(19) United States
(12) Patent Application Publication
(10) Pub. No.: US 2017/0124593 A1
(43) Pub. Date: May 4, 2017

(54) SYSTEM AND METHOD FOR CONTENT INTAKE, SCORING AND DISTRIBUTION

(71) Applicant: ATOMIC REACH INC., TORONTO (CA)

(72) Inventors: KENNETH CHARLES NICKERSON, AURORA (CA); MATIAS EZEQUIEL CABRERA, BUENOS AIRES (AR); BRADLEY MARC SILVER, TORONTO (CA)

(21) Appl. No.: 15/317,179

(22) PCT Filed: Jun. 9, 2015
(86) PCT No.: PCT/CA2015/000367

§ 371 Date: Dec. 8, 2016

Related U.S. Application Data
(60) Provisional application No. 62/009,492, filed on Jun. 9, 2014.

(51) Int. Cl. G06Q 30/02

(52) U.S. Cl. CPC G06Q 30/0263; G06Q 30/0269; H04L 67/02

(57) ABSTRACT

A system and a method for distributing digital content matched to web properties are provided. A plurality of digital content items is received. The content attributes of each of the digital content items is determined. The audience attributes of an audience of a web property is determined. The digital content items are matched to the web property by assessing the content attributes and the audience attributes. In response to the matching, the digital content items are selectively distributed to the web property.

### FIELD

This disclosure relates generally to platforms for managing creation and distribution of digital content. The disclosure further relates to systems and methods for content-based marketing.

### BACKGROUND

There is significant demand for relevant digital content.

This demand arises partly because of the effectiveness of content-based marketing. Studies have shown that content-based marketing can deliver exceptional results such as online traffic increases, spikes in lead generations, and improved customer engagement.

Content-based marketing requires a significant supply of relevant content. Producing sufficient content that is relevant and interesting can be challenging, time-consuming, and expensive. This is in part because consumers demand content that is informative, entertaining, and engaging.

For example, some sources estimate that most brands need to produce or acquire hundreds of pieces of content per month at an average monthly spend of around $25K, according to the Content Marketing Institute. As a result, the cost to acquire quality content can be too expensive for some brands to achieve sustainable return on investment (ROI). Finally, without the ability to select content based on its quality and relevance for a specific audience, and a community to support its distribution, it is difficult to optimize content marketing program performance.

To capitalize on the growing consumer demand for content, in some cases brands and bloggers have sought to partner in an effort to source and share one another's original content (e.g. Huffington Post, Fit Studio by Sears, or IQ by Intel). However, identifying content that is suited for a particular audience and generating enough amplification to maximize ROI can be challenging.

While certain automated content filtering and distribution platforms exist, these may not provide verification of the high quality, highly relevant content that is required for content-based advertising and therefore many businesses, or their agencies, resort to manual approaches, most often engaging writers to create original content based on specific attributes. Again, the cost can be significant which impacts on ROI, and also makes effective content-based advertising less accessible to small and medium sized businesses.

Thus, there is a need for systems and methods that address some of the mentioned requirements.

### SUMMARY

According to an aspect, there is provided a computer-implemented method of distributing digital content matched to web properties. The method includes receiving a plurality of digital content items; determining content attributes of each of the plurality of digital content items; determining audience attributes of an audience of a web property; matching the plurality of digital content items to the web property by assessing the content attributes and the audience attributes; and in response to the matching, selectively distributing the plurality of digital content items to the web property.

According to a further aspect, there is provided a system for distributing digital content matched to web properties. The system includes at least one processor, a network interface, and a computer readable medium in communication with the at least one processor. The computer readable medium stores computer processing instructions executable by the at least one processor to provide: a content collection component for receiving a plurality of digital content items by way of the network interface; a content assessment component for determining content attributes of each of the plurality of digital content items; an audience assessment component for determining audience attributes of an audience of a web property; a matching component for matching the plurality of digital content items to the web property by assessing the content attributes and the audience attributes; and a distributing component for selectively distributing the plurality of digital content items to the web property by way of the network interface, in response to the matching.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

The invention will be better understood when consideration is given to the following detailed description thereof. Such description makes reference to the annexed drawings wherein:

FIG. 1A is a system diagram illustrating system components, in accordance with an example embodiment;

FIG. 1B is a further system diagram of the platform of FIG. 1A, in accordance with an example embodiment;

FIG. 2A is a screen of a content editor, in accordance with an example embodiment;

FIG. 2B is another screen of a content editor, in accordance with an example embodiment;

FIG. 2C is yet another screen of a content editor, in accordance with an example embodiment;

FIG. 2D is a portion of screen of a content editor, in accordance with an example embodiment;

FIG. 3 is a screen of a dashboard for displaying content analysis results for an example content item, in accordance with an example embodiment;

FIG. 4 is a screen of a dashboard for displaying content analysis results for a set of recent content items, in accordance with an example embodiment;

FIG. 5 is a screen of a dashboard for displaying content analysis results for a library of content items, in accordance with an example embodiment;

FIG. 6 is another screen of a dashboard for displaying content analysis results for a library of content items, in accordance with an example embodiment;

FIG. 7 is a screen of a dashboard for displaying audience analysis results, in accordance with an example embodiment;

FIG. 8 is a screen of a dashboard for displaying audience activity, in accordance with an example embodiment;

FIG. 9 is a screen of a dashboard for displaying audience engagement, in accordance with an example embodiment; and

FIG. 10 is a flowchart of a representative workflow for content contributors, in accordance with an example embodiment;

FIG. 11 is a flowchart of a representative workflow for content consumers, in accordance with example embodiment;

FIG. 12 is a schematic diagram illustrating a computer system implementation, in accordance with example embodiments.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

The present disclosure provides a system and a method for distributing digital content matched to web properties. According to example embodiments detailed below, a plurality of digital content items is received. The content attributes of each of the digital content items and the audience attributes of an audience of a web property are determined. The digital content items are then matched to the web property by assessing the content attributes and the audience attributes. In response to the matching, the digital content items are selectively distributed to the web property. The matching may include calculating a score reflective of a quality of match between a particular digital content item and the web property. Such scores may be provided to content contributors and content consumers as feedback. Conveniently, the system and the method provided herein may facilitate more efficient content creation, content distribution, and content-based marketing.

### DEFINITIONS

“Content consumers” mean individuals or businesses who consume digital content of any type, using a network-connected device. Content consumers include any entities seeking content, whether these are brands who are seeking content for redistribution to their customers, or the customers themselves who ultimately consume the content. An audience makes up a group of contents consumers. A content consumer includes a brand, publisher, agency, or individual and members of their audience, the ultimate consumers of content or “end users”.

“Content” means digital content of any type or format, including articles, blog entries, messaging posts, blog posts, RSS feeds, and so on.

“Content marketing” is referred to as a marketing technique of creating and distributing relevant and valuable content to attract, acquire, and engage a clearly defined and understood target audience. The objective of content marketing is generally to drive profitable customer action.

“Contributor” means any individual, business, organization, government entity or institution that creates Content, and submits or makes available to the platform his/her Content. Contributors may also be referred to in this disclosure as “content creators”.

“End users” or “audience” refer to content end users such as individuals or businesses subscribing to a content channel, blog users, or visitors to a website.

“Platform client” means an individual, business, organization, government entity, or institution that subscribes to the platform for the purpose of reaching its audience, for example, an audience of consumers. Platform clients include, for example, brands.

“Properties” refers to any manner of destination for receiving Content or distribution of Content. A “property” includes, for example, a web site, web site area, e-magazine, blog, content feed, social network page or content channel, content delivery platform, and so on.

### Aspects and Implementations

In one aspect, a novel and innovative content marketing platform (10) is provided. The platform (10) integrates two main resources or components, and each of these is per se novel and innovative, namely a content hub (20), and a content distribution service or content distribution engine (22). Additionally, in one implementation, the content hub (20) and the content distribution service (22) are implemented to operate cooperatively as further described below.

The platform (10) connects contributors and consumers in new and useful ways, and enables a series of novel and innovative computer-implemented workflows related to automated content distribution across a plurality of properties associated with the platform (10) or its operator. The content hub (20) incorporates one or more tools or workflows that automatically score content in order to improve targeting of content consumers with content. Further details regarding content scoring are discussed below.

In another aspect, the content distribution service (22) may be associated with an entity that is separate from the operator of the platform (10) and the content hub (20). The content distribution service (22) may consist of a third-party platform that may be integrated with the platform (10) in a variety of ways. The content distribution service (22) may interface with third party platforms (e.g. Hootsuite™) to manage delivery of content through particular channels or to particular audience segments.

For example, an application programming interface may be used to obtain from the content distribution service (22) information regarding content performance and also audience parameters. This information may then be used to support the intelligent features of the content hub (20) described below. More specifically, the content distribution service (22) may include a feedback loop that extracts unique content consumer insights, and uses this information to improve the encoding of content by the content hub (20) with qualitative information. This encoding of content with qualitative information, in turn improves the ability of the platform to distribute content selectively and intelligently to audience channels with a higher degree of relevance and interest to the content consumer than is possible using prior art solutions.

In another possible aspect, the content hub (20) integrates with the content distribution service (22). In one aspect, the content distribution service (22) may be part of the content hub (20). In another aspect, the content distribution service (22) may be linked to the content hub (20). As explained in greater detail below, the content distribution service (22) includes one or more tools for enabling the automated distribution of content from the content hub (20) to a plurality of destinations which may include, for example, properties, in a targeted manner.

In yet another possible aspect, the content distribution service (22) allows content consumers to define parameters of their audience segments. These audience parameters may be defined manually or automatically, e.g., based on analysis of historically-consumed content. As explained in greater detail below, such audience parameters allow content to be matched or created to suit a particular audience segment, e.g., based on the sophistication level of a particular audience segment.

In one implementation, the content distribution service (22) includes a recommendation engine (50) that automatically analyzes content requirements, across multiple web properties or networks of web properties that are associated with the platform, and analyzes content available through the content hub (20), and in real time or near real time, recommends specific content for distribution to specific web properties or networks of web properties. Such analysis may be based, for example, on the aforementioned audience parameters. The recommendation engine (50) may automatically determine the quality of match between content and pre-defined audience segments. In particular, the recommendation engine (50) may calculate content-audience match scores to represent the quality of match. These match scores may serve as a predictor of how well content will perform with respect to pre-defined audience segments. These scores are then used to select recommended content for these audience segments. The scores may also be used to provide feedback to contributors, e.g., to assist contributors in tailoring content to suit a particular audience segment and thereby optimize performance of their content when distributed to that audience segment.

The recommendations generated by the recommendation engine (50) are used by the content distribution service (22) to selectively distribute content in a way that matches to the current audience requirements of the web properties or network of web properties. Further aspects of the features of the recommendation engine (50) are described below.

A skilled reader will understand that the platform (10) is described in terms of a content hub (20) and a content distribution service (22) for clarity of description, but in fact content creation, discovery, and distribution are related concepts, and in fact one advantage of some embodiments described herein is that these functions are closely integrated. In one possible implementation, the content hub (20) may, for example, enable content consumers to define one or more attributes for their consumption of content through the platform (10), e.g., attributes of the audience that will consume content, and these attributes may thereafter be used by the content delivery service (22) to automatically filter and distribute relevant content, based on these attributes, to one or more of their properties. Aspects of content distribution therefore may be handled by the content hub (20), and in one implementation, the content distribution service (22) may provide functions and features for automated distribution of content to properties.

One contribution of the inventors is a computer network implemented platform that permits the automated distribution of relevant content across multiple properties, thus reducing overhead normally involved in creating relevant content or filtering content assets for relevance.

Another related contribution of the inventors is that the platform (10) enables dynamic and intelligent distribution of content across multiple properties based on divergent content distribution strategies. In part this is based on the special dashboards provided by the platform (10) which are discussed in greater detail below. For example, in some embodiments, there is provided a scalable Internet platform that allows the configuration and implementation of such divergent content distribution strategies in an effective way. These may be based, for example, on content marketing based strategies that depend on specific audience attributes for particular properties. Further details regarding audience segmentation techniques are provided below.

In one aspect, the intelligent features (which may be implemented as part of the analytics utility (27) described below) may provide an intelligent layer or component in the platform (10) that feeds information to the various components of the platform (10) in order to streamline and increase the relevance of content created and distributed using the platform (10) or resources linked to the platform (10).

The content hub (20) is further described below. At a high level, the content hub (20) consists of one or more tools that may be accessed, for example, through one or more web areas, for enabling a plurality of users (14) to create or capture content relevant to content marketing strategies. The content hub (20) may include, for example, one or more areas dedicated to contributors, and one or more areas dedicated to content consumers. Further possible aspects of the content hub (20) are described below.

In one aspect, the content hub (20) includes a number of features or functions that are per se novel and innovative. The content hub (20) is designed to attract and retain contributors by providing useful and innovative tools for contributors that leverage the unique access to information regarding the interests and characteristics of the audience of content consumers in order to improve the reach and monetization of the content of contributors who are registered to the platform (10).

Also, the content distribution service (22) utilizes a series of innovative features that streamline, automate, and improve the relevance and effective distribution of content-based marketing. In particular, the content distribution service (22) includes or links to a content scoring engine (18) that provides for the first time content quality based distribution of content, thereby significantly improving the performance of content-based marketing. In one aspect, there is provided a content scoring engine (18) and related processes that enable automated scoring of content of varying types and having different content attributes, in a consistent or universal manner.

The content distribution service (22) also includes or links to a recommendation engine (50) that generates the above-noted content-audience match scores reflective of the quality of a match between content and pre-defined audience segments. This allows content to be matched to audience segments, which also significant improves the performance of content-based marketing.

In one further aspect, the content scoring and match scoring mechanisms are configured to be applied in an automated manner to content thereby contributing to the scalability of the platform (10). Further details regarding content scoring techniques and matching scoring techniques are provided below.

Also, the content distribution service (22) may incorporate various known tools or techniques for targeting content consumers with content. Additionally, the content distribution service (22) may incorporate a series of tools or may embody techniques that are new and innovative.

In one possible aspect, the content distribution engine (22) may include one or more mechanisms for capturing or collecting content consumer feedback, for example, by capturing views, comments, shares, likes or other types of feedback, provided using, for example, engagement features associated with a web property associated to the platform. In one possible implementation, the content consumer feedback provides a feedback loop to the platform (10). The content distribution engine (22) may include an analytics utility (27). The analytics utility (27) may incorporate one or more predictive analytics routines that (a) receive as input content consumer feedback, and (b) generate insights regarding audience segments and associated preferences. These insights may be for a defined period of time and for a specific web property or network of web properties. These insights may also be generated on and stored on a brand by brand basis. This information may be stored to the content distribution profiles referred to below.

For example, as the content scoring engine (18) identifies the appropriate audience for each topic or entity, the behavioral response from content consumers within each network and at each interval within a specified time-period yields behavioral insights about the audience that can be looped back into the analytics utility (27) for creating intelligent insights, based on application of one or more analytical operations. These analytical operations may be based on, for example, predictive analytics techniques.

For example, for a particular brand, based on audience responses, the platform (10) learns that a Facebook™ audience is comprised of females such as mothers at 10 am, teenage girls at 3 pm and professional women at 8 pm. This may be in contrast to a LinkedIn™ page which may indicate that the audience is comprised of professional women at 10 am and mothers at 8 pm. This level of insight will inform which topics to deliver to each digital property at key inflection points during a twenty-four hour period to optimize the performance of content. Additionally, these insights will integrate with the recommendation engine (50) to assist in the identification of sub-topics related to the primary topic delivered to the content consumer to further optimize content performance for customer engagement and conversion.

One insight of the inventors is that content marketing solutions generally are designed to target a minority of a market, which may be referred to as “opportunities” (for whom sufficient information may be available to support traditional content marketing techniques). Prior art solutions do not address, however, the larger part of the content consumption funnel, which consists of suspects, prospects, and leads.

Embodiments disclosed herein may allow the broader sales funnel to be addressed using content-based marketing. For example, in the past, brands have focused their marketing message on materials that address the specifics of the products or services being sold. As an example, a road bike cycling manufacturer will typically market the benefits of a new frame with an emphasis on the technical specifications and performance benefits of the design of the frame. This addresses the small percentage of consumers who are actively engaged in the purchase decision phase of the sales funnel. Content consumers of this type may be referred to as “opportunities”, based on the stage that they represent in the sales funnel. As an “opportunity”, the content consumer has typically made a decision to purchase, is evaluating the competitive landscape and is interested in interacting with technical details about the products and services being purchased. For content consumers that may be referred to as “suspects”, “prospects” and “leads”, their information needs are markedly different than those of “opportunities”, and “suspect”, “prospects” or “leads” represent the majority of content consumers. And yet prior art solutions may not address the different requirements of “suspects” over “opportunities”.

To continue with the bicycle example, the lifetime value of a road bike frame for the average cycling enthusiast can range from three to five years. As such, marketing materials about new bike frames for most cyclists is of little value until such time as they are ready to make a purchase, an event that occurs on average twice over a ten year period. At all other points in the content consumers' relationship with the brand, they may be mostly interested in myriad of sub-topics related to cycling such as, training guides, nutrition, local races, events, new equipment, etc., and least interested in technical information about a new bike frame. Yet promoting brand engagement between a content consumer who is a prospect, well in advance of a decision being made to buy a bicycle, is nonetheless of interest to the bicycle manufacturer. Content creators are now recognizing the importance and value of delivering this content to consumers as a method of maintaining brand engagement and generating faster sales conversions at the point of purchase, as a result of maintaining an ongoing interaction with content consumers. The challenge is that content creators are not well-structured to deliver the content required to meet the demands and needs of their content consumers or, evaluate the quality of the content they are producing in order to optimize it for engagement and ultimately, conversion performance.

Embodiments of the platform (10) may solve this problem using real-time content scoring and performance insights that content creators use in the production of content, predictive analytics and distribution guidelines for optimal engagement and recommendations of third party content that is relevant to the needs of the audience. As a result, the platform (10) may optimize content marketing program performance and may increase sales conversions.

In one possible implementation, the content distribution service (22) generates pre-amplification insights about the different audience segments associated with the platform (10). This information (as well as content scores) is then used by the recommendation engine (50) to determine the best suited target audience for each single piece of content.

The platform (10) may provide highly targeted matching of content to audience segments, and may thereby provide improvements over performance that is possible using prior art solutions.

The matching of audience segment to content, as disclosed herein, for example, permits the matching of the sophistication of the content relative to the comprehension level of a preferred audience.

For example, prior to the distribution of content, the analytics utility (27) may generate one or more information elements that are indicative of the suitability of specific content to a specific audience or audience segment.

Then, once content is distributed to content consumers across all potential digital properties (websites, mobile devices, social networks, etc.), audience-based insights are derived based on the behavioral responses such as a views, comments, likes, shares, scroll-time and other metrics reflective of how much of the content is viewed or consumed, etc., within each digital destination. These responses constitute performance based feedback and may be returned to the analytics utility (27) in order to generate further audience insights. Accordingly, the audience segment discovery and content delivery optimization and iterative related processes, and this may be reflected in the implementation of the platform, including the various system processes embodied therein.

Specifically, leveraging the content as the assessment mechanism, the behavioral response to the content yields audience insights about the digital property and enables segmentation of audience across all properties based on these insights. As usage increases over time, the sophistication of the audience-based insights improves, and may be used to generate predictive analytics for content segmentation by matching the sophistication of the content to the sophistication of the content consumer at key points within a twenty-four-hour period within and across each digital destination.

In another possible aspect, the content creator may contribute input to the audience/content matching features disclosed herein. For example, the platform may present a digital dashboard that is updated in real time or near real time, and present up to date audience or audience segment related information, for example, audience demographics, or audience interest attributes which may be based in part on audience member feedback obtained by the content distribution service (22). The content creator may add further insight or information regarding audience interest. For example, the content creator may learn that demographic A is active on a specific network at 10 am, while demographic B is active on that same network at 4 pm. The digital dashboard may provide the mechanism that enables the content creator to provide that feedback. As such, the recommendation engine (50) will suggest matching content to the needs of the respective consumers at various points in the daily cycle and the publishing engine will automate the distribution of content to match the needs of the audience in the same capacity.

The platform (10) provides a content performance engine with a series of unique and innovative features that provide scalability and also that include a number of intelligent and innovative features that reduce the manual work usually involved in contributors meeting the needs of content consumers and their audience. Furthermore, the platform (10) permits end users to receive, as part of content marketing campaigns, content that is more relevant to them.

In one aspect, the platform (10) relies on content quality rather than merely marketing power.

### Computer System

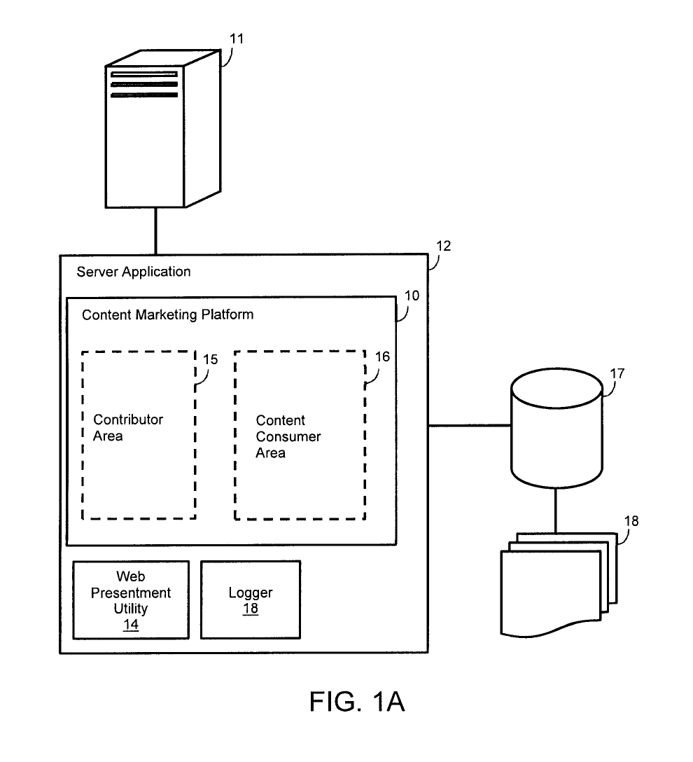

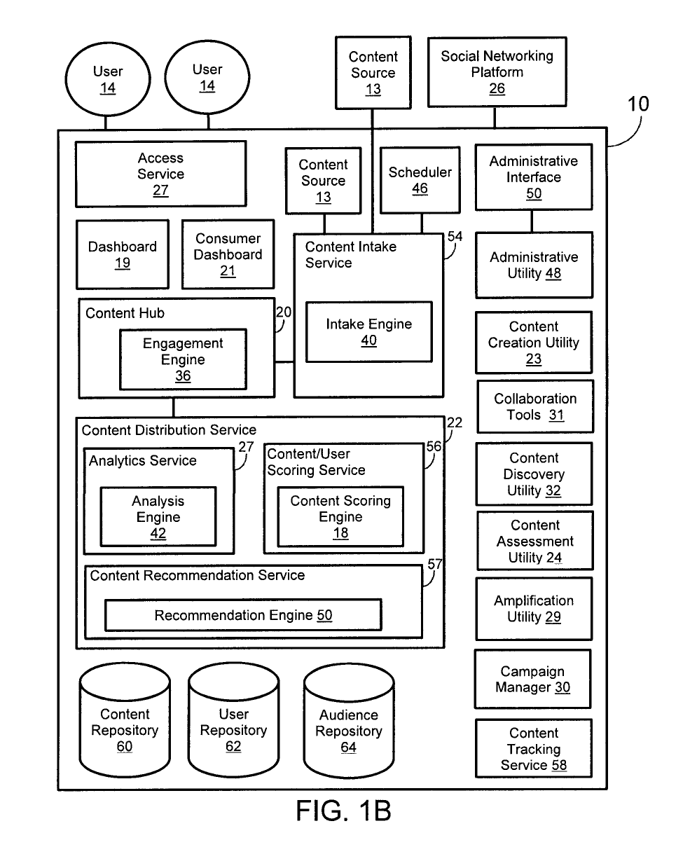

As best shown in FIG. 1A, the platform (10) may be implemented as an Internet service. One or more server computers (11) may include a server application or application repository (12). The server application (12) may include one or more tools for implementing platform (10), including the content hub (20) and the content distribution service (22). Further details regarding these tools are provided below.

As illustrated in FIG. 1B, platform (10) may include an access service (27) that allows users (14) to register or obtain access to the platform (10) or specific functions or features of the platform (10), including based on their user type. Access service (27) may allow users to register for access to the system and its services, either directly (e.g. through a human-to-computer interface), or indirectly (e.g. through a computer-to-computer interface). For example, contributors (14) may access contributor related features defining a “contributor area” (15) or equivalent. Content consumers such as brands or their agencies, may access a “content consumer area” (16) or equivalent. A database (17) may be linked to the server computer (11), and the access service (27) may include technology for ensuring that users access only their information. The database (17) may store content (18), as well as, for example, media assets of content consumers.

The platform (10) may also include a content intake component or service (54) that pulls content from one or more content resources (part of the platform or associated with a third party) and/or receives content from numerous authorized content sources. The content intake service (54) may support the ingestion of content from a number of different formats or intake mechanisms such as RSS, ATOM, CMS authentication, or others. Once a feed is connected, a process may be initiated between the intake process of the content intake service (54) and a system or web application associated with the content source. One or more communications may be exchanged regarding the state of a content source at any point in the content intake process.

In another aspect, the content intake service (54) may implement one or more scheduling functions, for enabling the period intake of content (for example, from a specific feed), and optionally based on a schedule stored to the content intake service (54). The content intake service (54) executes the schedule, and based on this at the scheduled time triggers an intake process for the relevant feed.

The content intake service (54) may be implemented to initiate multiple intake process threads in order to enable multi-source or multi-feed intake. The content intake service (54) may be implemented to permit concurrent processes in order to implement multi-source content intake. The relevant processes may be configured in order to reduce or eliminate duplication and to assign a managed state to each content source. States associated with content may include: check source, run source, create post object, process completely. Different processes may exist for specific source types such as RSS, ATOM, or CMS authentication.

The platform (10) may also include a content/user analysis component or service (56) that analyzes content received by the system, and users of the system, and derives metadata for the purposes of recommendations, search, and scoring. The content/user scoring service (56) scores content and users based on conditional sets of measures (with associated weights) using metadata derived through the analysis process, as further particularized below.

The recommendation engine (50) may be implemented as part of a content recommendation component or service (57), that is part of the platform (10), and that recommends content to users based on their use of the system. The content distribution engine (22) may be implemented as a content distribution component or service implemented by the platform (10) that allows users to push content to various properties or pull content to a property.

The platform (10) may also include a content tracking service (58) that tracks engagement with content which has been distributed by the system.

The platform (10) may also include a content repository (60), which may be implemented as a database of all content pulled or pushed into the system, including all derived metadata and scoring measure results associated with the content, and the content sources associated with the content.

The platform (10) may also include a user repository (62), comprising a database of all users and authentication tokens.

Various computer system architectures may be used to implement the computer system and computer implemented methods of the present invention. For example, the system may be implemented using a client/server architecture, where the functionality described is implemented to a server application, accessed by multiple users from their computer devices, whether these are a desktop computer, a laptop computer, a tablet computer, or a smart phone. Various distributed computer architectures may be used, and the features described herein may be implemented as cloud networking solution.

Features may be associated with website areas or screens based on features of a web presentment utility (14), which may be implemented to the server application (12). Possible user workflows are described below.

### Content Hub

The content hub (10) may include for contributors a content creation utility (23) having one or more different tools for either posting content from third party digital content creation and publishing platforms. The content hub (10) may also include, for example, blogging or micro-blogging tools, and also may include or link to social networking functions or a social networking platform (26). An example of a third party content creation and publishing platform that may connect to the platform (10) includes Tumblr™.

In an embodiment, content hub (10) may be implemented as a browser plugin. In another embodiment, content hub (10) may be implemented as a plugin or similar add-on allowing for integration into a content management system (CMS).

The contributor area (15) may incorporate a content assessment utility (24), which may incorporate one or more project management functions that allow contributors to create and assess content creation projects, including, for example, a real-time scoring function that assess the overall quality of the content and its relevance to a targeted audience. Scoring may be granular such that separate scores are assigned to each portion of the content (e.g. each section, each paragraph, etc.), all of which may be updated in real-time as contributors make changes to the content.

The contributor area (15) may incorporate a document editor allowing a content creator to generate new content items. Content items submitted through this document editor may be automatically analyzed (e.g., a score assigned) in manners disclosed herein.

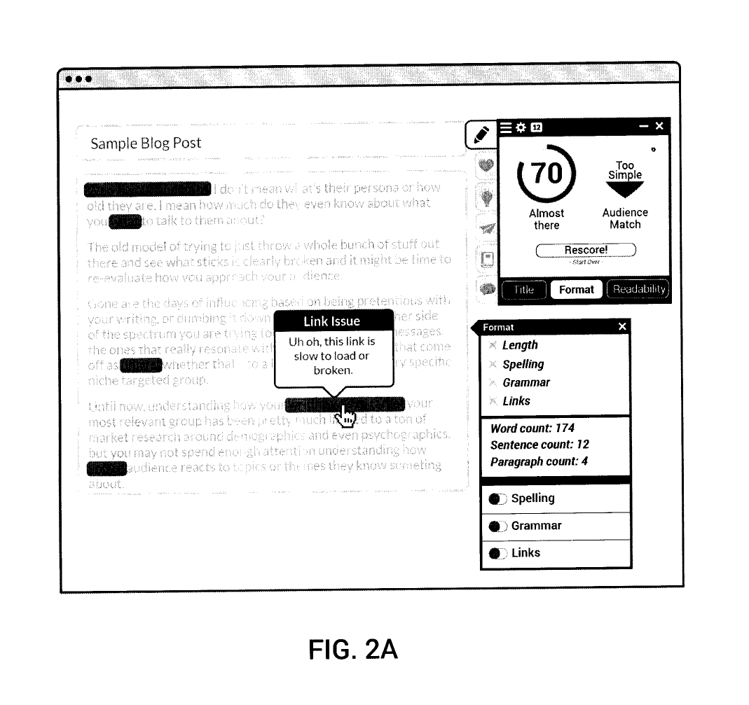

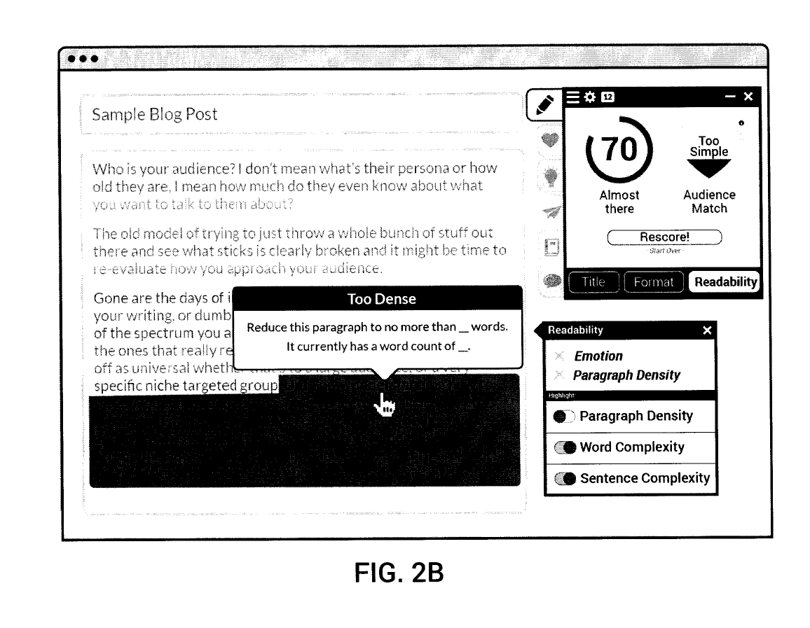

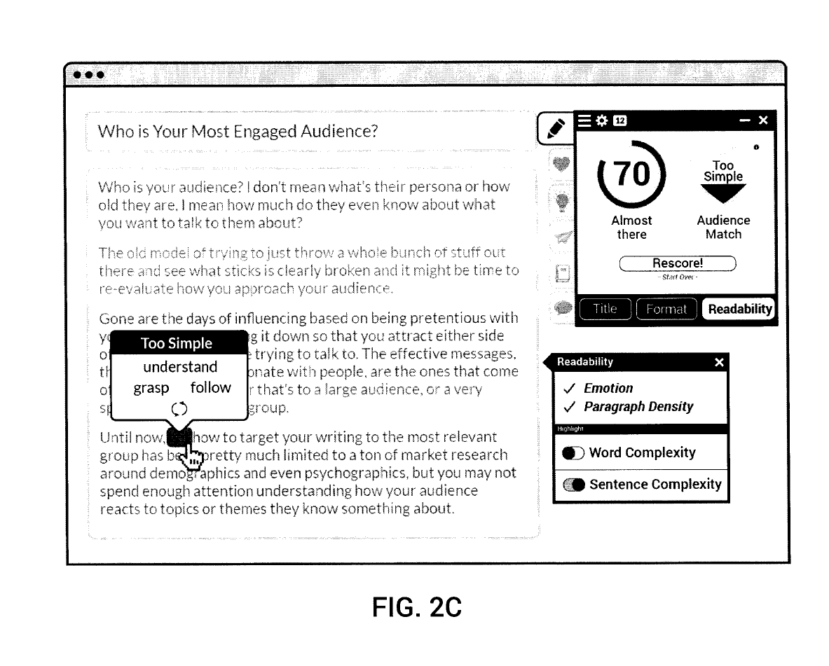

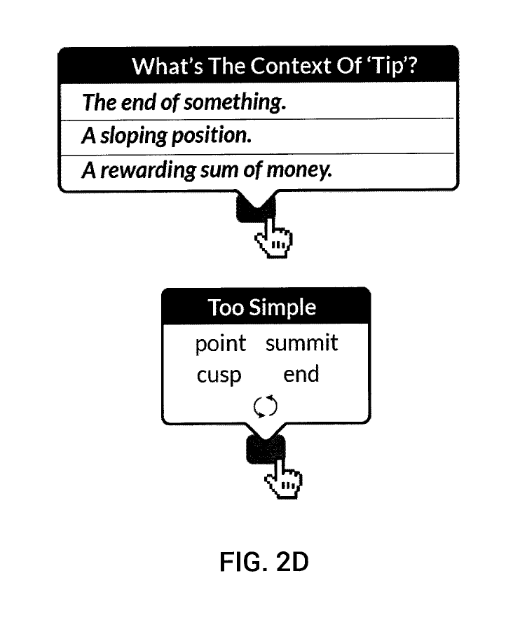

FIG. 2A, FIG. 2B, FIG. 2C, and FIG. 2D are each a screen (or portion thereof) of a document editor incorporated into contributor area (15), in accordance with an example embodiment.

As depicted, the document editor may be configured to provide recommendations to correct various parts of a content item, e.g., based on linguistic analysis, structural analysis, link analysis, etc.

FIG. 2A depicts a recommendation regarding a link in the content item. As shown, the document editor can provide a warning that a link is slow to load or broken.

FIG. 2B depicts a recommendation regarding a paragraph that exceeds a certain length (e.g., too many words, or too many sentences relative to a pre-defined threshold). As shown, the document editor can provide a suggestion to reduce the length of the paragraph.

The contributor area (15) may include, for example, a plug-in to an online Thesaurus to enable the content creator to modify the language of the content to improve its suitability, relevance, or emotional content, in order to meet the needs of a specific audience and/or to improve engagement with a specific audience. The contributor area (15) may include a word recommendation engine that automatically invokes the Thesaurus to suggest suitable words, e.g., to provide simpler synonyms for complicated words to suit the target audience, or vice versa, e.g., to provide more complex synonyms for simple words to suit the target audience.

FIG. 2C depicts a recommendation provided by the document editor to replace a simple word “get” with a more complex synonym (e.g., one of understand, grasp, follow), as provided by the Thesaurus. In circumstances where the meaning of a word may vary depending on context, the document editor may prompt a user to identify the context. In this way, synonyms appropriate for the context may be suggested. For example, as shown in FIG. 2B, the document editor prompts the user to identify the context of the word “tip”, as entered into the editor. Upon receiving an indicator that the context is “the end of something”, the document editor suggests appropriate synonyms, as shown.

The contributor area (15) may also provide recommendations for replacing passive voice phrases with active voice phrases, or vice versa.

The contributor area (15) may also include a word count allowing contributors to assess the size of the content, e.g., relative to any prescribed limits.

The contributor area (15) may include a review filter that distinguishes between content items that may be automatically published, and content items that require editorial (i.e., manual) review. The review filter may implement various review rules that may be customized for particular distribution channels. In this way, certain content items (e.g., content items meeting a minimum scoring threshold) may be automatically distributed without editorial review, and distribution may be streamlined.

The contributor area (15) may also include a dashboard (19). The dashboard (19) may include for example: a list of active content objects or categories with content with status for each content object or category of content objects indicating the status of their distribution, revenue generated for each content item, and information regarding audience segmentation or audience reach information.

The contributor area (15) may include a news feed configured to present news of interest (e.g., recommendations for when and where to publish content items, audience activity alerts, etc.) to contributors.

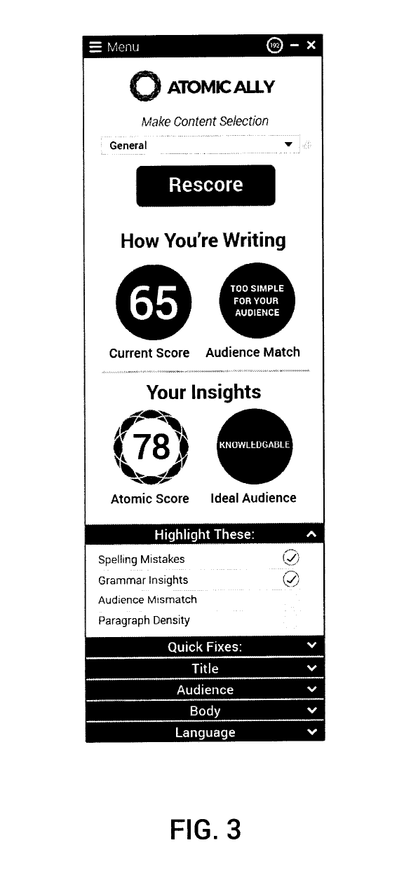

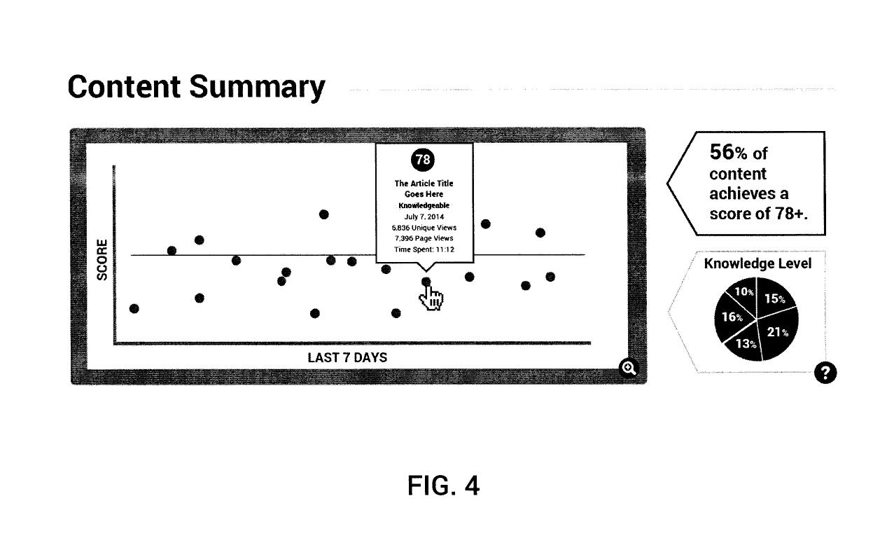

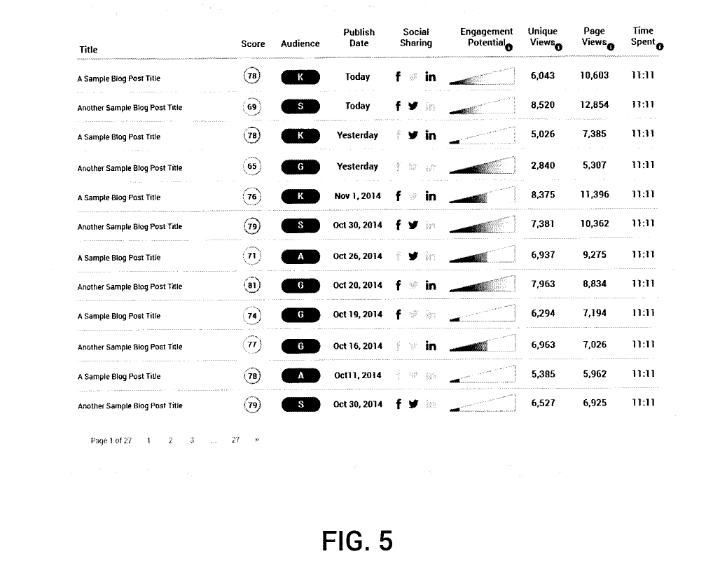

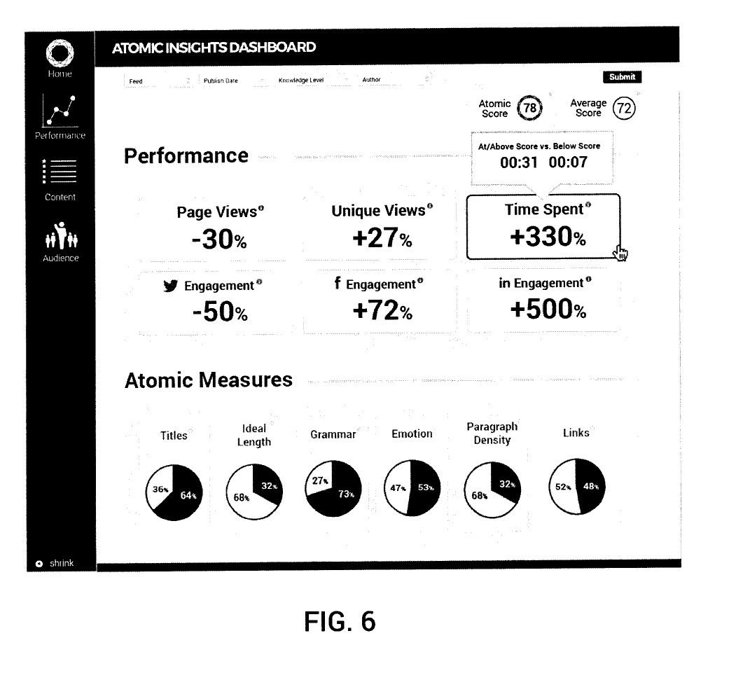

FIG. 3, FIG. 4, FIG. 5, and FIG. 6 are each a screen of dashboard (19), configured for displaying content analysis results, in accordance with an example embodiment.

FIG. 3 depicts a screen providing content analysis results for an example content item. As shown, the screen includes a score “65” calculated in manners disclosed herein. This score may, for example, reflect a quality of match between the content item and the audience of a particular web property, calculated based on the reading ease of the content item relative to the comprehension level of the audience. The score may be accompanied by an assessment of any mismatch between the reading ease and the comprehension level, as may be assessed by recommendation engine (50). For example, as shown, the content item has been determined to be too simple for the audience and notification of same is provided in this screen.

This screen may also present additional information such as, for example, an aggregate score for the contributor or a target score for the contributor (e.g., an “Atomic Score”), as further described below. Other additional information may include, for example, an assessment of an ideal audience segment for the contributor's web property. In this example, the ideal audience segment has been assessed to be the “Knowledgeable” segment. In one example, the ideal audience segment may be identified based on the most engaged audience segment.

In one example implementation, an audience may be segmented as “General”, “Knowledgeable”, “Specialist”, “Academic”, and “Genius”). The characteristics of these segments may be as follows:

General: beginner, novice, basic, introductory, starter.

Knowledgeable: aware, familiar, intermediate, informed, in the know.

Specialist: advanced, trained, well-versed, qualified, skilled.

Academic: scholarly, collegiate, masterful, brainy, bookish.

Genius: expert, brilliant, intellectual, cream of the crop, best of the best.

Other ways to divide audience members into segments are possible, as will be apparent to those of ordinary skill in the art.

The screen may also present specific recommendations to the contributor for improving the content item's score, as may be generated by recommendation engine (50). For example, as shown, such recommendations may include a recommendation to change the title of the content item, a recommendation to adjust the grammar of the content item, and so on.

FIG. 4 depicts a screen providing content analysis results for a set of recent content items. As shown, the analysis of content items may be graphed according to their score. In this way, a contributor may conveniently determine historic performance information at a glance. Each data point in the graph may be selected by the user to obtain further performance metrics such as number of unique views, number of page views, time spent by readers, or the like.

This screen may also provide additional information, such as a breakdown of proportion of content items by each item's associated comprehension level (or knowledge level). As shown, this breakdown may be presented in the form of a pie chart.

Optionally, each data point in the graph may be colour-coded to depict each item's required comprehension level.

Optionally, the time span of this graph may be user adjustable. As shown, this time span is 7 days. However, the time span may be adjusted to be a longer or shorter period, in response to user input or in response to changes in user-specified parameters.

FIG. 5 depicts a screen providing content analysis results for a library of content items. As shown, results may be presented in the form of a list of content items. For each content item, there may be an indicator of the item's score, the content item's target audience segment, and other various metrics.

Conveniently, this screen may also display user-activatable buttons in association with each content item. Each button may be activated to publish the associated content item to a pre-defined distribution channel, e.g., a website, a social media platform, a feed, or the like.

FIG. 6 depicts a screen providing content analysis results for a library of content items. As shown, the content analysis may provide metrics based on assessment of each content item according various criteria including, length/quality of the item's title, length, grammar, emotional content, paragraph density (e.g., number of sentences per paragraph), number/quality of links. The metrics may be presented as a percentage of content items in the library that satisfy a pre-defined threshold for each of the noted criteria.

The criteria and/or pre-defined thresholds may vary according to particular target audience segments. The criteria and/or pre-defined thresholds may vary according to particular distribution channels. The criteria and/or pre-defined thresholds may vary over time, e.g., to adapt to performance metrics.

As shown, this screen may also provide various performance metrics relating to content access such as e.g., changes in page views, changes in unique views, changes in time spent, as well as changes in engagement for various distribution channels.

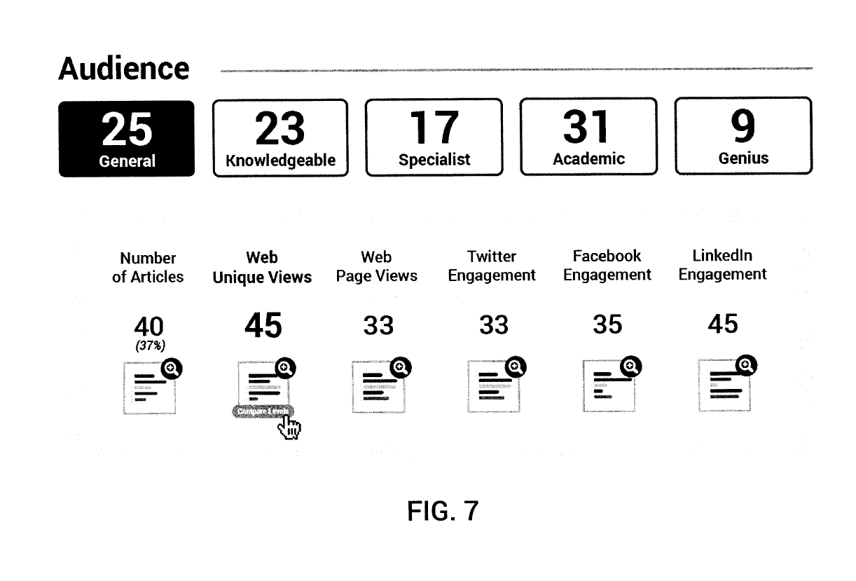

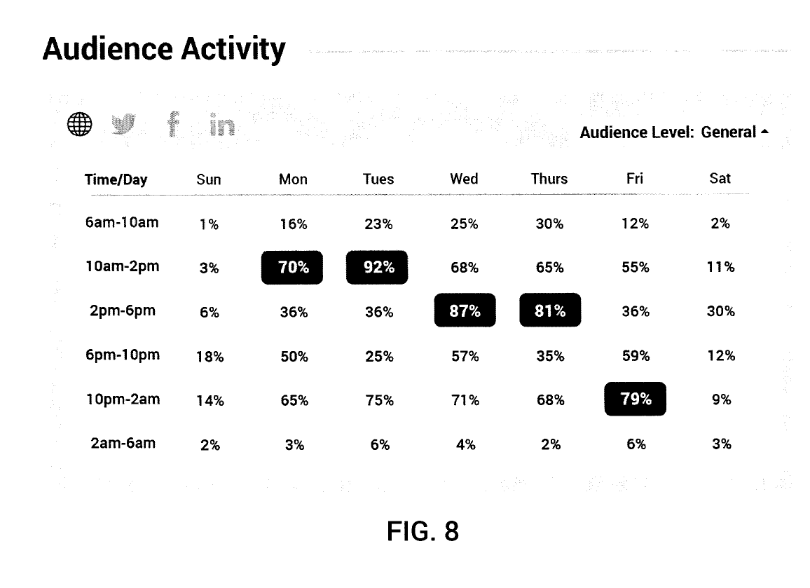

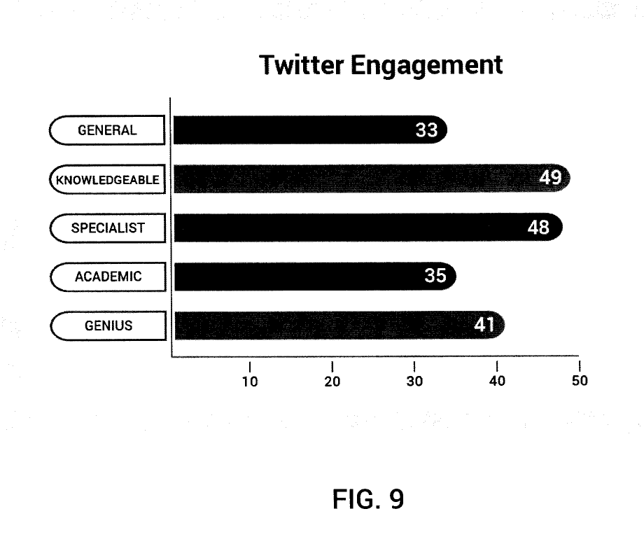

FIG. 7, FIG. 8, and FIG. 9 are each a screen of dashboard (19), configured for displaying audience analysis results, in accordance with an example embodiment.

In particular, FIG. 7 depicts a screen showing various audience attributes associated with a particular web property. For example, this screen may show a breakdown of engagement level by audience segmentation (e.g., General, Knowledgeable, Specialist, Academic, Genius, etc.).

In one implementation, the engagement level may be calculated using measures of degree of web and/or social interactions (e.g., number of views, visits, shares, likes, comments, or the like). In one implementation, the engagement level may be calculated using a weighting system that takes into account the relative value/importance of each type of interaction.

In one implementation, the engagement level may be calculated taking into account the number of audience members in a particular audience segment.

In one implementation, the engagement level may be calculated relative to the amount of content suited for a particular audience segment. In this way, the engagement level may be normalized based on the amount of content for each segment, and facilitate comparison across segments.

This screen may also provide consumption and/or engagement metrics for each particular audience segment. Such metrics may include, for example, number of content items viewed, number of unique views, number of page views, or the like. Such metrics may also include, for example, a metric indicative of a degree of audience engagement for each distribution channel (e.g., each social media network).

FIG. 8 depicts a screen showing audience activity rate according to time of the day, and day of the week, for a particular web property. Audience activity may be filtered according to audience segment, and/or according to distribution channel (e.g., a website, a social media platform, a feed, or the like).

As depicted, for the General audience segment and a website distribution channel, activity is highest during weekdays, with peak periods varying depending on the day of the week. Such analysis may, for example, be used by the system to generate recommendations for when new content items should be published, for each particular distribution channel. As will be appreciated, such recommendations may be based on the target audience segment of particular content items.

FIG. 9 depicts a screen showing audience engagement according to each audience segment, for a particular distribution channel, i.e., Twitter™.

The contributor area (15) includes one or more tools that allow contributors to find one another, and collaborate in taking advantage of content distribution opportunities. These collaborative features (31) may be implemented with features that can be used in social networking platforms, based on which the platform (10) may suggest connections to contributor A based, for example, on similarity of content created, the consumers of their content or their, performance of their content, their business model for monetizing content, or other criteria. Based on this, the platform (10) may suggest to Contributor A, Contributor B and Contributor C as connections, where contributor A accepts contributor B. Contributor A and Contributor B may then each receive social media feeds including updates regarding open projects of one another. Contributor A and Contributor B may also access various communication tools through the platform (10) such as, for example, email messaging, Internet chat, video conferencing, posting to a collaborative area, and other similar communication features. Contributor A and Contributor B may also assist one another in promoting each other's content, including using mechanisms outside operation of the platform (10). In one aspect of these social, content collaboration aspects, Contributor A and Contributor B may use the audience amplification utility (29) as explained below.

In one aspect, the contributor area (15) is designed to provide an easy to use, engaging, and collaborative online service that contributors can use to create and manage the creation of their content.

In another aspect, the contributor area (15) is provided to contributors free of charge, or alternatively contributors are charged initially for premium features, but depending on the level of their activity on the platform (10) (such as, for example, referring contributors or content consumers to the platform, or a trust score for their content calculated based on feedback provided by a contributor's peers through platform (10) or a connected platform) associated fees may be reduced or eliminated.

A further aspect that attracts contributors to the platform (10) is that for the first time content distribution is integrated with the content creation platform (10). This has a number of valuable and surprising implications. Many opportunities, especially high value opportunities that command a significant fee, or premium fee, may be near real time or at least time sensitive. Contributors can command a higher rate for their content if they are able to direct the creation of contributions in a way that is responsive to demand from content consumers. The integration of the contributor area (15) with the content consumer area (16) provides access to insights and trend information regarding content consumer demand that is unprecedented in the prior art.

For example, a further aspect that attracts adoption of the platform is the ability for integration with third party platforms that interact with content in numerous forms. Examples include platforms such as content management systems (Wordpress™, Tumblr™, etc,), content marketing platforms (Eloqua™, Marketo™, HubSpot™), customer relationship management systems (Salesforce™, Zoho™, Microsoft Dynamics™) or, publishing platforms. In this capacity, content creators will have a unique ability to assess their content at the point of creation, prior to distribution, analyze the sophistication of each of their content creators which will enable matching of topic assignments to content creators for optimization of performance, relative to the needs of each audience segment within each digital destination. The integration between the platforms will enable the interaction between the content creator and the data to occur on the dashboard which will reside within the third party platform's native environment.

In one aspect, the server application (12) includes or links to a logger (28) that logs system related events including posting of content, attributes of content posted, content contributor actions, content consumer actions, and any other platform activity. These system-related events may be stored to the database (17). The server application (12) may also include an analytics utility (27) that analyzes the event information so as to generate analytics that may be used by the system, for example, to help contributors in creating relevant content. Access to this information may be provided in real time or near real time, and also presented in a way that is relevant to contributors, thereby providing unique and innovative decision support to contributors. In one implementation, the server application (12) includes or links to a content analysis engine (which may include, for example, a semantic analysis tool) for analyzing, for example, a contributor's library of past content, and new content being created can be analyzed in real time, and relevant suggestions based on the output from the content analysis engine (42) may be provided in real time to guide or inform the contributor.

For example, the analytics engine (27) provides insights based on the quality of the content relative to all other similar type documents within the platform. Such examples would include originality, focus of key argument engagement potential for the selected audience or recommendations regarding a better suited audience, etc.

The contributor area (15) of platform (10) may also include an audience amplification utility (29) that allows platform users, both contributors and content consumers, to drive engagement, and may be implemented as one or more simple and easy to use applications that enable optimized and targeted content sharing. The audience amplification utility (29) may include intelligence driven automated distribution of content based on audience based performance analysis and optimization. For example, as the engine is unique in its ability to determine the audience sophistication level for a content entity and then analyze the response from within each destination, thereby identifying the compilation of the audience on that specific network, the content distribution engine (22) incorporates intelligence for time based distribution of content on a segmented basis to each network at the appropriate time of the day.

In one aspect, the contributor area (15) allows contributors to share one another's content, which provides amplification of audience. The audience amplification utility (29) in one aspect allows contributor A to share content with contributor B, and also promote contributor B's content to one or more channels to which contributor A already provides content. Contributor A's relationship with the content consumers who subscribe to the one or more channels is likely based on trust, and therefore contributor A will be careful only to promote contributor B if s/he meets quality attributes, but once Contributor A promotes content of contributor B, contributor B will benefit from amplification and more specifically an increase in views, engagement, and leads.

In another aspect, the contributor area (15) may provide suggestions to contributors in the form of social media annotations regarding how to perform social media updates. For example, suggestions regarding how to post a particular content item to Twitter™ may be provided.

Additionally, the performance feedback loop provides audience insights that are derived from specific user responses to a topic or article from within each social network and web property. These results are leveraged by the recommendation engine (50) in the form of intelligence based recommendations and pre-amplification performance indications. For example, the system may learn that on a Facebook™ page, the distribution of audience segments across a 24 hour period ranges between adult females and teenagers. It may also learn which content topics each segmented most engages with and which sub-topics, or which tangential topics are of key relevance to the audience. The recommendation engine (50) in one aspect may generate recommendations that educate the content creator in creating content, or the content distributor regarding when to deliver content, where the content should be distributed and which topics and sub-topics should be delivered. For example, such recommendations may be based on data collected for audience activity, e.g., as shown in FIG. 8. Additionally, the system may define pre-amplification performance expectations relative to historical performance.

This is an example of how contributors through the platform can collaborate, through promotion of content or cross-promotion of content. Promotion of content may occur, for example, through Twitter™ where by promoting content or a contributor, that content or any content for a contributor will be promoted through the promoter's channels, for example, by re-tweeting the content automatically.

In one aspect, the audience amplification utility (29) is implemented using one or more social features through a social networking platform (26) that may be made part of the platform (10) or linked to the platform (10). For example, contributors can recommend other contributors or specific content items, and recommendations can be made to specific content consumers based on insights as to a particular content consumer's campaigns or the interests or characteristics of their audience.

In one aspect, the social networking platform (26) may be used by contributors to develop various social networks for creating content such as groups with curators and the like. Members of a group may find other members with compatible background or content. Members may use social media functions to “trust” a curator, which may then bestow on a curator one or more curator rights or obligations. One or more content creator users may, for example, bestow one or more content creator users with curator status for a group of content creators. This may bestow the curator with rights to manage one or more activities including providing further input to content scoring, providing input to audience attributes, in order to improve content performance.

In one aspect, one or more rules or terms and conditions may be linked to the platform (10), including to ensure that the bargain between the operator of the platform (10) and one or more user groups is held up. For example, contributors may receive access free of charge to the tools making up the content scoring utility (24), but in exchange contributors may be required to submit only original content to the platform (10).

The contributor area (15) may include one or more features for managing the intake of content from contributors to the platform (10). This may include for example, providing one or more screens to contributors for: (A) selecting a content source and one or more associated attributes, and (B) providing information required to access content and publish content digitally such as by providing a web syndication format URL, such as for an RSS or other feed.

The content consumer area (16) may include a number of different functions or features that allow content consumers to manage their consumption of content. In one aspect, content consumers or their personnel may provide one or more attributes defining various aspects relevant to defining content of interest to the content consumer or their audience (whether a customer base, potential customer base or otherwise). These attributes may also be discovered automatically by the platform (10).

For example, the platform (10) in one implementation facilitates manual selections by content consumers in the form of following a topic, individual contributor or through a notification in the form of a “like” or “dislike” of a particular article. These inputs may be aggregated and assessed over time in conjunction with behavior based performance actions by content consumers from within a particular network. These results may be provided to the recommendation engine (50) as a method of specifying recommended content, topics and contributors to follow for the purpose of distributing their content to drive improved network performance.

In one possible aspect, the platform (10) identifies parameters for a content consumer's audience automatically based on analysis of historic content consumed by that audience. Such historic content may be fed into the platform (10) by a content consumer from various content sources such as Google Analytics™, Facebook™, Twitter™, or the like. Historic content may be fed into the platform (10) by operation of the content intake service (54) using a variety of intake formats or mechanisms, as discussed above.

The platform (10) includes an audience segmentation service or utility that analyzes the historic content to automatically determine parameters of that audience, which results in segmentation of the audience in a novel and innovative way. Such audience parameters may be determined separately for each content distribution channel or distribution feed of a content consumer.

For example, the audience segment service may analyze the historic content to determine one or more common topics or themes.

The audience segmentation service may also analyze the historic content to determine a sophistication level of the audience. In an exemplary implementation, the level of sophistication of the audience may be determined to be one of “knowledgeable”, “academic”, and “general.” As will be appreciated, the level of sophistication may be impacted by the source of the content, e.g., the platform or feed from which the content originates. For example, the audience for content on the Facebook™ platform may be determined to be of “general” sophistication for one content feed or source, while the audience for content on the Twitter™ platform may be determined to be of “knowledgeable” sophistication. However, different sophistication levels, including the opposite sophistication levels, may be determined for a different content feed or source on those platforms.

Advantageously, by determining the sophistication level of the audience automatically from historic content, mistaken beliefs held by content consumers regarding the sophistication level of their audience may be dispelled or avoided.

The platform (10) may also analyze the historic content to determine attributes of that content such as content type (e.g. a letter, a post, or an article), grammar properties (e.g. active voice or passive voice), writing style (e.g. descriptive, narrative, expositive, or persuasive), etc. Such analysis may be performed by analysis engine (42) of analytics service (27), as further detailed below. Other content attributes may also be determined by the various analyzers of analysis engine (42), as further detailed below. Such content attributes, as determined, may be deemed to be the preferred attributes of the content consumer's audience.

The platform (10) may store parameters determined for a content consumer's audience in the audience repository (64).

The content consumer area (16) may include or link to a campaign manager (30) or similar utilities, that when executed allow a content consumer, or their personnel, to manage one or more campaigns involving content-based marketing. The information logged by the logger (28) may be used to log information regarding the interests of particular content consumers or that of their end users. The analytics engine (27) may implement one or more segmentation techniques for targeting properties with selected content based on analysis of information relevant to audience for each property.

The content consumer area (16) may also include a consumer dashboard (21) for reviewing various metrics for content performance. The platform (10) may be configured to extract content performance information from one or more properties or associated website management system or WMS for example. This information may be further analyzed using the analytics utility (27) in order to present in the consumer dashboard (21) relevant information for configuring one or more content distribution profiles for the content consumer which are used by the content distribution service (22) to configure and modify channels or streams and selectively publish these channels or streams across the properties associated with a particular content consumer.

The integration of the utilities of the contributor area (15) and the content consumer area (16) enables the matching of content seekers with curated or trusted content that meets the criteria of content consumers in an intelligent and responsive manner. The platform (10) may include an intelligent content discovery utility or engine (32) that utilizes the analytics engine (27) in order to discover of one or more characteristics of an audience or audience segment, and enables content to be delivered to content consumers (or their properties) based on the characteristics of their audience.

A further aspect of the platform (10) is a novel and innovative content scoring utility or engine (18). The content scoring utility (18) is based on one or more novel and innovative computer implemented methods for measuring the quality of content. More particularly, the content scoring utility (18) is based on a universal standard devised to assess the quality of content. The content scoring utility (18) permits the filtering of content based on targeting attributes or attributes associated with a property or properties that was no previously possible. The content scoring utility (18) significantly streamlines or automates the distribution of content to properties automatically, in a way that meets content marketing requirements, and therefore reduces significantly overhead associated with pursuing content marketing based on current best practices.

### Content Distribution Service

The platform (10) includes a content distribution service (22) that based on the content discovery utility (32) dynamically defines a plurality of content distribution channels, and intermittently locates relevant content, based on content consumer demand (or demand of their audience) and delivers content periodically through the content distribution channels.

The content distribution service (22) may be implemented as a computer network implemented content exchange. The content exchange may be based on a push or pull architecture (or both). An Application Programming Interface (API) may be associated with a website of a property, for receiving or pulling content from the server computer (11) that is relevant and of interest to the audience of the property. Various other implementations are possible. For example, a website management system or WMS may include one or more interfaces for connecting to the platform (10) to receive or pull relevant content.

In one implementation of the content distribution service, content is pushed to content consumers registered to the platform (10) by matching the interests and characteristics of their audience with the content.

The content distribution service (22) may include one or more auto-filtering tools that ensure that content is published to one or more channels and/or properties automatically based on a series of criteria that are relevant to distributing content that is relevant to characteristics or interests of a particular audience or audience segment. As explained in greater detail in the use case below, the content distribution service (22) ensures that relevant content is delivered automatically, for example, to Microsite A once it is available.

For example, either through an API or intelligent platform distribution functions, content can be deployed to a scheduler for optimized distribution. This is achieved through audience behavior and response analysis of historical content based on user actions on each specific piece of content, topic and network (views, likes, shares, comments, votes, etc.). Over time, audience based segmentation insights are created that inform the scheduler on how to distribute content by time and location to optimize performance and engagement as the content is specifically selected for the needs of a particular audience segment.

In one aspect of the content distribution service (22), it includes a novel and innovative content scoring utility (18) that may be used in part to filter content for distribution as part of the content distribution service (22). In one aspect, the content scoring utility (18) analyzes content items such as a post to generate new meta data for the content item such as (i) the number of words contained in the content item, and (ii) a reading ease score such as the Flesch-Kincaid reading ease score.

The use of a reading ease score to score digital content, and then filtering content based on this score was not previously disclosed in any known prior art solution. Use of a reading ease score provides an efficient and reliable method for scoring content that is useful for online marketing purposes, and further that can be universally applied to any text based content. The inventors have discovered that a mismatch between reading easy and demographic attributes produces significant problems in delivering content that is of interest to an audience segment. For example, presenting more complicated or wordy text content to a young audience generally speaking does not provide good content performance. Conversely, presenting content that incorporates simpler syntax and is based on a restricted vocabulary may not provide positive content performance with an audience segment that is generally educated and over 35 years in age.

Reading ease provides a useful input to determining the relevance of content for a particular audience, an indication of how an audience is naturally segmented across different networks at various points within a twenty-four hour period and predictability into how and where an article is most likely to perform in a predictive format.

Other content scoring mechanisms exist however these do not reflect a number of important dimensions of content quality.

In one implementation, the content scoring engine (18) allows users to submit content for scoring based on the content analysis and scoring processes thereof. In one implementation, the content scoring engine (18) is implemented using the analytics engine (27), by configuring the analytics engine (27) to include the content scoring routines described herein.

The content scoring engine (18) can include one or more tools for intake; analysis; and scoring of content on an automated basis. Further details are provided below.

In another aspect, the content distribution service (22) includes a content recommendation service (57) having a recommendation engine (50). The recommendation engine (50) recommends content for distribution to particular distribution feeds and channels. Recommendations are based, at least in part, on the content scores determined by the content scoring engine (18).

In one implementation, recommendations are also provided in response to automatically matching content to an audience, using the determined audience parameters. The recommendation engine (50) may retrieve such audience parameters from the audience repository (64). As described above, these parameters may be determined automatically from historic content consumed by the audience, and may include common (i.e. preferred) topics and themes, the sophistication level of the audience (e.g., general, knowledgeable, or academic), and preferred content attributes (e.g., content type, writing style, etc.). The recommendation engine (50) evaluates the suitability of each available content item based on these audience parameters, e.g., whether the content matches the sophistication level of the audience, whether the item relates to a preferred topic or theme, whether the item is of the preferred type, whether the item is written in the preferred style. Based on this evaluation, for each content item, the recommendation engine (50) generates a content-audience match score that reflects the proximity of the item to a particular audience segment's consumption preferences, as reflected in the audience parameters. For example, an item matching the audience's sophistication level will score higher, while an item that does not match the audience's sophistication level will score lower. Similarly, an item having structure or writing style similar to an audience's preferred structure or style will score higher, while an item having structure or writing style dissimilar to the audience's preferred structure or style will score lower.

The match scores serve as predictors of how well the content will be consumed by a particular audience segment, e.g., with respect to how much of the item will be read/consumed, whether the item will be recommended or shared, etc.

Thus, the calculated match scores may be used to select content for distribution to particular consumers or groups of consumers, e.g., by way of particular channels. For example, items scoring above a pre-defined threshold may be automatically selected for distribution. This threshold may be set by content type, feed, platform, etc. The recommendation engine (50) may also select content for distribution by comparing the calculated match score against an optional optimal score for a particular type of content, or a particular audience segment.

Aside from selecting suitable content for distribution, calculating the match scores provides numerous other advantages. For example, the match scores may be provided in real-time to content contributors, allowing contributors to make changes to content iteratively in an effort to improve scoring. In this way, contributors are also able to determine the connection between specific changes to content and the match scores.

In an aspect, contributors may be provided with a dashboard allowing contributors to view their scores, scores for contributions by other contributors, and aggregate scores. The dashboard also allows contributors to compare their scores against average scores, e.g., for all content, for content created by other contributors, for content relating to a particular topic, for content distributed to a particular audience segment or through a particular channel, etc. The dashboard may also provide the contributor feedback regarding the attributes of high-scoring content items, e.g., revealing that content regarding specific topics tend to score higher, or that longer articles tend to score higher. The dashboard may also allow contributors to track scoring of their content over time, and identify factors contributing to any changes in scoring over time.

In an aspect, contributors may be provided with a set of recommendations for improving match scores. Contributors may also be assisted in setting target scores for their contributed items.

Advantageously, the match scores assist contributors, and content marketers/creators to decide what content to create or promote. For example, contributors may use the match scores to direct efforts and expenditures towards high-scoring content.

The match scores also allows for more efficient management of advertising. For example, advertisements may be directed to content more intelligently based on expected performance of that content, and marketing objectives may be more tightly matched to particular content. For example, an advertiser may choose to place advertisements only in the highest-scoring content items. Bidding for impressions and other bidding strategies may also be adjusted based on expected performance of particular content items.

No prior art solution is known that provides a universally applicable mechanism for measuring the quality of digital content, and suitability for particular audience segments, regardless of content and medium.

### Workflow

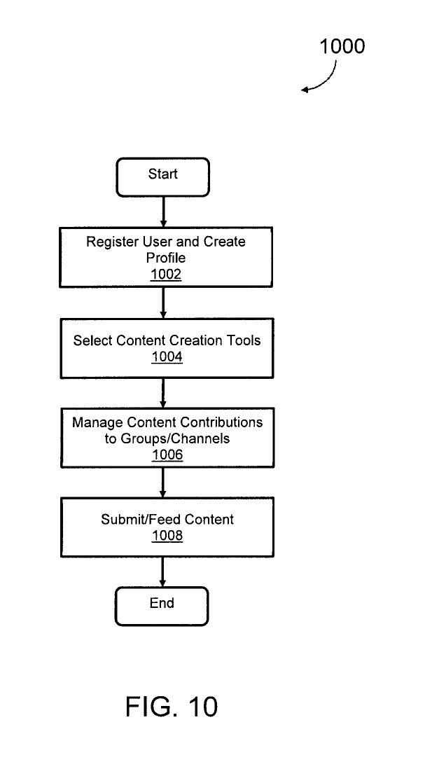

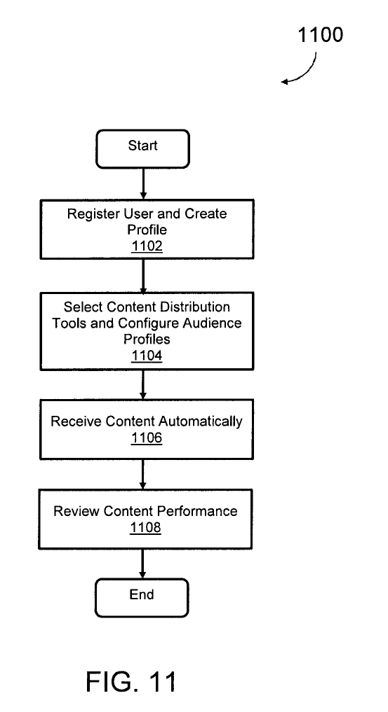

FIG. 10 and FIG. 11 illustrate representative workflows. As depicted in FIG. 10, contributors, in one representative workflow may:
(A) at block 1002: register as a user, and create their profile; this may be in response to an invite made by another contributor using the social networking platform (26);
(B) at block 1004: select the tools that they want from the content creation utility (23); and optionally the contributor discovers contributor groups and submits relevant content to one or more contributor groups;
(C) at block 1006, contributor accesses their dashboard where they can manage their contributions to groups (of contributors) and channels (associated with content consumers);
(D) at block 1008, content is submitted or fed to the system, for example, by providing an URL for a contributor's blog, which automatically submits content, but is only published by the content distribution service if the content passes the auto-filtering tools of the platform (10), including the content scoring engine (18) and the recommendation engine (50).

As depicted in FIG. 11, content consumers, on the other hand, may:
(A) at block 1102, register as a user, create their profile;
(B) at block 1104, select one or more content distribution tools that they want to use, and configure one or more audience profiles for their properties; they can also configure content attributes such as category attributes, topics, contributor profile attributes, and minimum content scores;
(C) at block 1106, receive content automatically to their properties; and
(D) at block 1108, access a content consumer dashboard to review content performance metrics for their content and optionally modify their content attributes accordingly.

### Further Details

The content hub (20) may incorporate an engagement engine (36) that in one aspect is configured to implement one or more of the following functions or function sets: (A) acquisition of contributors to the contributor hub (20), (B) systematic engagement of contributors to intensify their engagement with the platform (10) and campaigns associated with the platform, and (C) matching of campaigns to contributors, or targeting contributors using campaigns (i) to intensify engagement, and/or (ii) to promote brand objectives.

In one aspect, content sources and content items (such as posts) each have a state that is logged by the logger (28) that enables both content sources and posts to be managed as they move through the various platform processes including: (A) intake using, for example, the content intake service (54) implemented to the server application (12), (B) analysis using the analytics utility (27), which may provide an analysis engine (42) and also (C) scoring as a sub-process of the analytics utility, or scoring engine (18).

The logger (28) can provide access to other components regarding process status for each content source and content item.

The intake engine (40) may be configured to retrieve content items from content sources. In one aspect, the intake engine (40) checks to see if a content item already exists on the platform (10) or resources associated with the platform (10). If it does not, a content item is created on the platform (10) to represent the content item in the system. The intake engine (40) may be triggered, for example, by a web application linked to the platform (10) adding a new content source, or a scheduler (46) may be activated periodically to find and ingest new content items from previously added content sources.

In one aspect, intake engine (40) may include an intelligent scraper that may be trained to scrape content from a particular content source. For example, the scraper may be trained by a user to identify particular parts of a content item. In one example, a user may retrieve a reference content item, and select the item's title, and then activate a “Title Selected” button of the scraper. In response to this input, the scraper stores a record of where to find the title for content items from the particular content source. In similar manners, the scraper may be trained to find the content body, author(s), publication date, or the like.

The scraper may also be trained to ignore certain parts of a content item, and thereby avoid ingesting such parts. For example, a user may select certain portions (e.g., corresponding to a navigation bar), and then activate a “Remove Element” button of the scraper.

Once trained, the scraper may be activated to automatically ingest content items from a content source, for use at platform (10).

In one aspect, intake engine (40) may be configured to retrieve analytics data (e.g., relating to audience engagement) from external sources such as Facebook™, Twitter™, LinkedIn™, Google™ Analytics, or the like. Conveniently, such external sources may be used to collect data, which may then be aggregated at platform (10) and further analyzed to provide the audience and content insights disclosed herein.

In one aspect, once content items are created in the platform (10), this triggers the analysis engine (42) to analyze content items such as posts. The analysis engine (42) may include one or more analyzers or content analysis operations implemented to the analytics utility (27). The may include for examples: (A) an identify topics analyzer; (B) and identify and validated relate URLS analyzer; (C) a word count analyzer; (D) a syllable count analyzer; (E) a sentence count analyzer; (F) an offensive word count analyzer; and (G) a link count analyzer. Various other analyzers may be included such as, for example, sentiment analyzer or a thesis analyzer. The analytics engine (42) may also connect to various services, repositories or libraries in order identify, determine, and calculate relevant metadata for supporting the content filtering/distribution operations disclosed herein.

The analysis engine (42) may also, for example, analyze for spelling or grammar. For example, the scoring engine (18) may automatically detect whether the content is written using an active voice or a passive voice.

The analysis engine (42) may also, for example, analyze the content for style of writing. For example, such analysis may automatically determine a content item's writing style as being expository (e.g. explaining a subject in the absence of the author's opinion), narrative (e.g. author is included in the story), persuasive (e.g. containing the author's opinion), or descriptive (e.g. describing a character, event, or place).

The analysis engine (42) may also, for example, analyze any reader comments annexed to the created content using any of the analyzers and criteria described herein. This analysis may be performed periodically or in real-time as comments are submitted by readers.

In one aspect, the analysis engine (42) may also include analyzers for analyzing multimedia content included in content items. Such multimedia content may include, for example, images, audio clips, video clips, or the like. For example, analysis engine (42) may include an image analyzer that analyzes the content to determine the number of images, the number of images relative to amount of textual content (i.e. “density” of images), the location of images relative to textual content (i.e. “distribution” of images), image resolutions, or any meta-tags defined in association with the images, etc. Similarly, analysis engine (42) may include a video analyzer that analyzes the content to determine the number of videos, the density of videos, the distribution of videos, video durations, video resolutions, or any meta-tags defined in association with the videos. As will be appreciated by a skilled reader, similar analyzers may be provided for other types of multimedia content, e.g., audio content. Optionally, voice-to-text conversion may be applied to appropriate multimedia content, and text analyzers described herein may be applied to any converted text.

In another aspect, the analysis engine (42) may also include analyzers for analyzing the writing strength of content items. For example, the analysis engine (42) may perform “5-W-and-H” analysis to assess whether the exposition of the content addresses “who”, “what”, “where”, “when”, “why”, and “how”. The analysis engine (42) may also, for example, assess writing clarity, repetition, consistency, and uniqueness. Such analysis may be performed, for example, using conventional techniques such as phrase matching. Such analysis may determine whether certain keywords are used with a sufficient frequency or density within the text, as preferred for certain types of content. Such analysis may determine the overall structure of a content item, e.g., based on where keywords or phrases appear in that content item. Such analysis may also be used to evaluate the overall impact, force, or polarity of a content item.

The analysis engine (42) may include analyzers for particular portions of a content item. For example, the analysis engine (42) may include analyzers configured to analyze titles, heading, subheadings intro paragraphs, outro paragraphs, or the like. Having regard to a content item's title, for example, the analysis engine (42) may assess the length of the title, whether or not the title contains keywords, pre-defined positive or negative words, superlatives, second-person pronouns, etc. Having regard to intro/outro paragraphs, the analysis engine (42) may, for example, perform phrase matching to determine whether keywords appear in those paragraphs to assess their strength.

The analysis engine (42) may also analyze the formatting or layout of particular portions of a content item. For example, the analysis engine (42) may assess font properties of a title, heading, or subheading (e.g. whether it is bolded or displayed in a larger or more prominent font).

In one aspect, the scoring engine (18) is configured to include scoring mechanisms for content items (such as posts) and also optionally users of the system, including contributors. In one implementation, a plurality of measures are provided that may be applied to content items, based on a series of rules, depending on the results of the analysis of the content item based on the operations of the analysis engine (42). These measures may include for example: (A) a volume measure, (B) an ideal volume measure, (C) a readability measure, (D) a link validity measure, (E) an offensive content measure, (F) a strength measure.

Other measures are possible, such as, for example, scoring based on spelling or grammar of content. For example, when the analysis engine (42) has detected whether a content item is written in active voice or passive voice, the scoring engine (18) may assign a score based on prior knowledge of whether active voice or passive voice is preferred for a particular content type, content channel, or audience segment.

For scoring contributors, various mechanisms are possible, including the use of the following measures: (A) average content score measure for the contributor; and (B) contribution frequency measure.

A skilled reader will understand that various implementations of the content scoring mechanisms are possible. In one implementation, (A) each measure has a weight (1), a value relative to what it is measuring, and a normalized value to provide a score out of 100, (B) measures can be an addition or a universal multiplier, an example of a universal multiplier may be age of post, to degrade total score over time.

In a further aspect, weights may be assigned across the mentioned measures. Various other weight scores may be used and in fact in one aspect of the platform the analytics utility (27) may assist administrators in calibrating or optimizing a weighting to achieve performance objectives.

In a further aspect, the scoring processes may be implemented as follows:
(A) the scoring engine (18) dynamically loads all measures and runs each of them for every content item (such as a post);
(B) a scoring process or formula may be applied that may consist of:

$${S}_{g} = \frac{1}{{W}_{i}} {\sum }_{i = 1}^{n} {N}_{i} \times {W}_{j} {\prod }_{j = 1}^{n} {N}_{j}$$

where: S_{g} is the final general score for a given post; Nᵢ represents normalized values for each measure marked for addition; Wᵢ represents the weight for each measure marked for addition; Nⱼ represents normalized values for each measure marked as a multiplier; and Wⱼ represents the weight for each measure marked as a multiplier.

This process provides a lot of flexibility, for example, a multiplier measure may be applied easily that will affect everything, for example, the age of a post can lower the score despite other factors. Each measure can have a different impact based on its weight. The final general score can be normalized to fit a scale of 0 to 100. The significance of particular measures may vary according to content type, distribution channel, or audience parameters. As such, modifying the weights allows the measures and final general score to be tuned for particular distribution scenarios.

In another aspect, a reading ease score is used for the first time for automated content scoring of digital content. In another aspect, a reading ease score is defined for different audiences, for example, based on age:

| Target Audience | Reading Ease Score |
|---|---|
| Elementary School Students | 70-100 |
| High-School School Students | 50-69 |
| College Students | 30-49 |
| Graduates, Professionals | 10-29 |
| Geniuses, Superheroes | 0-9 |

Regarding ideal volume score, this may be based on average size for high-quality content, including, for example, of a certain type. The closer the content item's volume is to the “idea” or the norm, the higher ideal volume score that will be assigned.

For example:

| Number of Sentences | Score |
|---|---|
| 0-15 | 0 |
| 16-25 | 1 |
| 26-60 | 5 |
| 60-120 | 10 |
| 121+ | 6 |

Regarding a volume measure, various mechanisms may be used for creating a score for content based on volume. One example includes Equation: 0.0.5*# of syllables+0.3*# of words+0.2*# of sentences, i.e. a weighting whereby 50% of the weight is accorded to syllables, 30% to words, and 20% to sentences. This provides a measure of volume that is more accurate across different types of text than merely word count. Paragraph diversity creates a subjective trigger of quality.

The link validity measure may be implemented using one or more tools that check to make sure that links in a content item are not “dead”, and a score may be based on a percentage of valid links in the content.

The offensive content measure may be applied using one or more known analyzers for determining offensive content or content that is likely offensive. The associated score may be applied by counting the number of worlds in the content that are likely to be offensive. This score may then be normalized based on the relationship between the percentage of non-offensive words relative to total words.

The writing strength measure may be applied using the output of the analysis engine (42). This measure may, for example, reflect the clarity, repetition, uniqueness, strength of thesis, etc., of a content item. A measure may be applied based on the 5-W-H analysis described above. Similarly, a measure may be applied based on the grammatical voice analysis described above. The measure may be applied taking into account the type (e.g., blog post, article, etc.) of the content item.

Multiple strength measures may be applied, each corresponding to a particular portion of a content items. For example, a separate measure may be provided for titles, headings, subheadings, and particular paragraphs. Aggregate measures may be calculated by combining the measures applied for particular portions.

As previously stated, new content being created can be analyzed in real time, and relevant suggestions based on the output from the content analysis engine (42) may be provided in real time to guide or inform the contributor. For example, suggestions may be provided in real time in contributors to improve writing strength, e.g., to use keywords more frequently or consistently, to improve the strength of title, headings, paragraphs, to change the grammatical voice, to change the number or placement of multimedia content, etc. Relevant suggestions may also be provided based on the content-audience match scores generated by recommendation engine (50). For example, suggestions may be provided in real-time to contributors to improve the match score. Areas of a content for which suggestions are being provided may be automatically highlighted or flagged for the contributor's attention.

As previously stated, contributors themselves may also be scored in the platform (10). This may be based, for example, the average score across all content items for a contributor. Furthermore, social engagement data may be used to influence an overall contributor score. As noted, each contributor may also have a target score (or “Atomic Score”)

For example, the participation of a social network audience on a relative basis is much more indicative of engagement and the impact of quality content over generic content for the purposes of generating website traffic and leads than the absolute size of a network, and is also a measure of the relative influence of an audience. A blogger with a small but highly engaged audience may be more valuable to generating engagement and traffic than a brand with a large but non-descript and less engaged audience. As such, establishing a contributor score that is comprised in part by a content score and in part by a network engagement score is a method of determining the value of an individual as both a contributor and distributor of content.

Additional content related factors may be used to score content, these include: (A) originality of content (relative to existing content in the platform (10)); (B) popularity of associated topics; (C) number of times content is published to a channel (D) number of page views content has received; (D) social network activity after it has been shared by the platform (10); and (E) user feedback, such as thumbs up/down, or other mechanism.

In one aspect, the content scoring utility (18) is implemented so that an overly low score is not assessed as this would insult contributors. Rather, the content scoring utility (18) includes or links to a suggestion engine that can make suggestions to contributors for improving content in a way that may result in an improvement in an associated score.

The content hub (20) may also include one or more tools for motivating other contributors to register to the platform (10). In one aspect, the platform (10) (A) collects detailed information regarding contributors; (B) is operable to analyze their information so as to discover insights regarding the motivations of contributors, by generating a series of attributes that help categorize contributors, and enable the matching of contributors to campaigns or content consumers that are likely to motivate the contributors to create relevant content.

The attributes for categorizing contributors mentioned above may be stored to a profile, by operation of a profile manager (34).

The platform (10) may include an administrative utility (48) that may be connected to an administrative interface (50) operable by administrative users. The administrative utility (48) may include one or more tools that generate metrics on activities and outcomes for various users by operation of the platform (10) and may permit administrative users, for example, to optimize content scoring or content targeting processes.

### Business Model

Various business models may be employed in relation to the platform (10). In one aspect, the content scoring engine (18), and the content creation utilities (24) are used for free. Content consumers such as enterprise can pay for custom content channels. Brands may pay for branding content, which may be tracked through an URL and engagement bar. Exclusive access to content may require payment of premium fees, which may be subject to a revenue share between relevant contributors and the operator of the platform (10).

### Google™

The importance of a specific implementation of this aspect is provided by way of example in the documentation provided by the Google™ Webmaster Guidelines. These state: “Provide high-quality content on your pages, especially your homepage. This is the single most important thing to do. If your pages contain useful information, their content will attract many visitors and entice webmasters to link to your site”.

### Further Workflows

In one aspect, a computer system implemented method for promoting campaigns using contributors is provided including:

(a) creating one or more campaigns, a campaign including (i) one or more activities (such as a challenge) organized based on stages, (ii) one or more attributes of the campaign for enabling the matching of campaigns to contributors, and optionally (iii) one or more incentives associated with the completion of activities by one or more contributors accepting participation in the one or more campaigns through the computer system;

(b) matching the one or more campaigns with one or more contributor users associated with an contributor hub linked to the computer system (by matching campaign attributes with contributor attributes), and targeting the matched contributor users to participate in the one or more campaigns;

(c) based on one or more contributor users accepting participation in the one or more campaigns (“participating contributors”), engaging the participating contributors using an engagement engine that automatically directs messaging to the participating contributors based on the stages, and through the contributor hub and/or external networks linked to the computer system;

(d) tracking engagement of the participating contributors with the one or more campaigns using relevant events logged by the computer system, and calculating one or more engagement scores for the participating users based on the logged events; and

(e) providing feedback to the participating contributors based on their engagement with the one or more campaigns, including optionally applying the incentives based on the engagement scores.

The following describes a representative workflow for contributors engaging with the platform (10), in accordance with another aspect:

(a) Contributors sign in to the platform (10) using platform or social credentials;

(b) Contributors are presented one or more web pages showing their challenges, points, levels, badges and rewards related to their campaigns;

(c) Contributors respond to challenges, e.g. a challenge to provide a referral in connection with an active campaign (e.g. request for a referral of a potential new corporate subscriber for a new SaaS platform);

(d) If challenge is accepted, a related engagement workflow is initiated and thereafter the platform targets the contributor with a variety of messaging components;

(e) Activities responding to the engagement workflow are tracked within the computer system, and also within third party networks linked to the computer system (such as social networking environments); and

(f) Directed messaging to the contributor includes messaging designed to encourage progress of the contributor across two or more stages that are part of the engagement workflow, and also to report to contributor on their progress.

### Advantages of Some Embodiments

Various advantages of some embodiments are already mentioned above. In addition, some embodiments may:

Permit creation of high quality content at scale.

Creates an environment where there is active participation by contributors. This may provide a more engaging experience for contributors and motivates them to create more relevant, high quality content.

Provide a more cost effective solution for brands who want to engage their audience using content-based marketing.

Increase digital marketing metrics including page views, engagement levels, and monetization through sales/advertising/leads.

In some embodiments, the platform (10) allows contributors and content consumers to be matched based on the quality and relevance of their content for one another's audience.

In some embodiments, platform members are able to run custom queries or rely on a system of intelligent algorithms that automatically identify and recommend relevant content from the ecosystem based on the interests of their target audience.

In some embodiments, the platform (10) provides a unique method of discovery and matching content to enable users to curate and publish selected content to their websites and social media channels.

In some embodiments, the platform (10) provides access to relevant content at scale in a timely manner, and the ability to cover a much broader array of topics that are meaningful to content consumers and provides to contributors amplification of original content at unprecedented levels.

In some embodiments, the platform (10) helps brands improve their search engine page rank results, generate incremental sales conversions and improve customer engagement.

In some embodiments, the platform (10) combines the power of high-quality content, community participation and content marketing functionality to deliver optimized program performance and results.

In some embodiments, the platform (10) may increase page views, deliver new visitors to properties who spend a longer time on the relevant site with better content engagement.

In some embodiments, the platform (10) may provide more leads, sales and advertising monetization.

### User by Individuals

The platform (10) has been described in relation to content-based marketing. However, platform (10) may also be used by individuals to improve the performance of their content, e.g., with respect to readability, grammar, etc. Such other individuals may include, for example, contributors to creative writing platforms such as Wattpad™, or commenters posting on a discussion forum or a comments section of a news site, or the like.

### Further Aspects of Implementation

In a particular implementation, at least three sets of computing devices may be provided. Each set of computing devices may comprise one or more computing devices linked by a network. Typically, at least one set of computing devices would generate content marketing campaign attributes and send these over the network to a second set of computing devices. The second set of computing devices receives the content marketing campaign attributes and locates relevant content based on audience characteristics and distributes located content to a third set of computing devices. A fourth set of computing devices may be used by contributors to engage with the platform to create content and manage the monetization of their content through the platform.

Various users include platform client users (administrators) and contributor users may be associated with any manner of network-connected computer device. The network-connected device may a computer device such as a desktop computer, laptop computer, tablet computer or other similar device, connectable to the platform via the Internet, for example, by means of a browser session, in order to access one or more web forms that may correspond to the dashboards and other user interfaces described above.

The network-connected device may also be a mobile device such as a smart phone, and completion of various activities may occur, for example, using a mobile application loaded to the mobile device or smart phone. Further implementation details are provided below.

Further enhancements may be provided wherein one or more of the network-connected devices are mobile devices or wirelessly networked devices. For example, the network may be or include a wireless network, the wireless network including a wireless gateway for linking the wireless network to the Internet. The network-connected devices as previously described may consist of wirelessly networked devices that are operable to access the Internet via a wireless gateway. The wirelessly networked devices described may include a browser for interacting with the server (11) to access functions of the server application (12) implementing all or part of the content marketing platform (10). Alternatively, the wirelessly networked device may include a mobile application, which may include one or more utilities or features allowing users to submit, manage, or retrieve data for content, content channels, scoring, or audiences, e.g., by way of one of the dashboards described herein. The wirelessly networked devices could also be equipped with additional functionality for providing information regarding users that enables the targeting of particular users, including, for example, a GPS receiver operable to provide GPS location information to invite particular users to complete tasks or sub-tasks or to allocate tasks to particular participating users. The wirelessly networked devices may also include one or more accelerometers or other movement sensors operable to provide movement-based or gesture-based information. Thus the messaging to be returned to the platform may include location, movement and/or gesture relevant content.

It should be understood that the wirelessly networked device as described may consist of a hand-held two-way wireless paging computer, a wirelessly enabled palm-top computer, a mobile telephone with data messaging capabilities, a portable digital media player, or a wirelessly enabled laptop computer, but could be any type of mobile data communication device capable of sending and receiving messages via a network connection. The majority of current mobile communication device users, however, use a mobile telephone with data messaging capabilities, such as server addressing capabilities such as Short Message Service (“SMS”) or Multimedia Messaging Service (“MMS”) or data including GPRS or 3G. Thus, the functionality described herein may be provided from mobile communication devices that are relatively common and inexpensive.

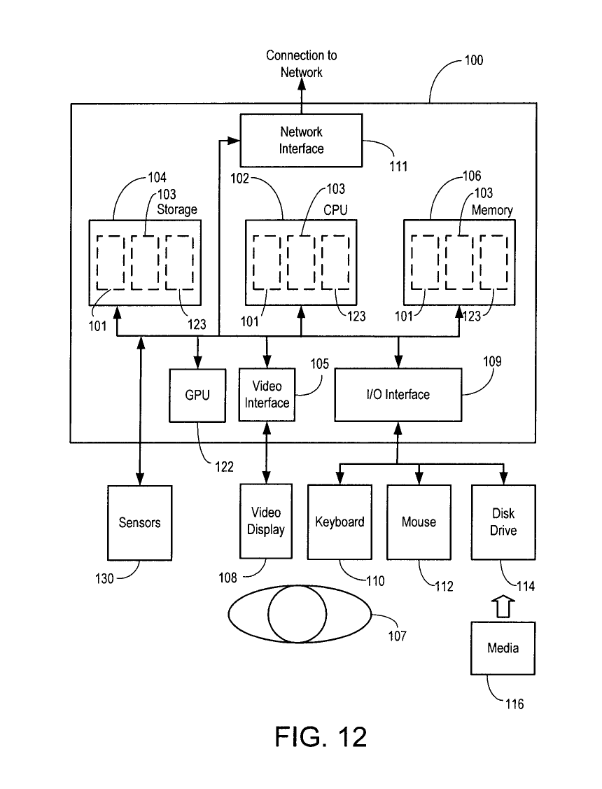

A suitably configured computer device, and associated communications networks, devices, software and firmware may provide a platform for enabling one or more embodiments as described above, e.g., platform (10). By way of example, FIG. 12 shows an example computer device (100) that may include a central processing unit (“CPU”) (102) connected to a storage unit (104) and to a random access memory (106). The CPU (102) may process an operating system (101), application program (103), and data (123). The operating system (101), application program (103), and data (123) may be stored in storage unit (104) and loaded into memory (106), as may be required. Computer device (100) may further include a graphics processing unit (GPU) (122) which is operatively connected to CPU (102) and to memory (106) to offload intensive image processing calculations from CPU (102) and run these calculations in parallel with CPU (102). An operator (107) may interact with the computer device (100) using a video display (108) connected by a video interface (105), and various input/output devices such as a keyboard (110), mouse (112), and disk drive or solid state drive (114) connected by an I/O interface (109). In known manner, the mouse (112) may be configured to control movement of a cursor in the video display (108), and to operate various graphical user interface (GUI) controls appearing in the video display (108) with a mouse button. The disk drive or solid state drive (114) may be configured to accept computer readable media (116). The computer device 100 may form part of a network via a network interface (111), allowing the computer device (100) to communicate with other suitably configured data processing systems (not shown). One or more different types of sensors (130) may be used to receive input from various sources.

Embodiments disclosed herein may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

While the above description provides examples of one or more embodiments of the invention, it will be appreciated that numerous other embodiments may be within the scope of the present invention, as defined by the following claims.

1. A computer-implemented method of distributing digital content matched to web properties, said method comprising:
receiving a plurality of digital content items;
determining content attributes of each of said plurality of digital content items;
determining audience attributes of an audience of a web property;
matching said plurality of digital content items to said web property by assessing said content attributes and said audience attributes; and
in response to said matching, selectively distributing said plurality of digital content items to said web property.

2. The method of claim 1, wherein said matching comprises calculating a score reflective of a quality of match between a given one of said digital content items and said web property.

3. The method of claim 2, wherein said matching comprises comparing said score to a pre-defined threshold.

4. The method of claim 2, further comprising providing said score to a contributor of said given one of said digital content items, an administrator of said web property, or an advertiser.

5. The method of claim 4, further comprising receiving a update to said given one of said digital content items from said contributor, in response to providing said score to said contributor.

6. The method of claim 2, further comprising providing a suggestion to a contributor of said given of said digital content items for improving said score.

7. The method of claim 1, wherein said audience attributes comprise an attribute reflective of a sophistication level of said audience.

8. The method of claim 1, wherein said audience attributes are received from an administrator of said web property.

9. The method of claim 1, wherein said audience attributes are determined by analyzing historic content consumed by said audience.

10. The method of claim 9, further comprising receiving said historic content.

11. The method of claim 1, wherein said content attributes comprise spelling and grammar attributes.

12. The method of claim 1, wherein said content attributes comprise a topic or a theme of each of said plurality of digital content items.

13. The method of claim 1, wherein said content attributes comprise a writing style of each of said plurality of digital content items.

14. The method of claim 1, wherein said audience attributes comprise at least one of a preferred content topic, a preferred content theme, and a preferred writing style.

15. The method of claim 1, wherein said plurality of digital content items is received by way of a computer network.

16. The method of claim 1, wherein said distributing is by way of a computer network.

17. A system for distributing digital content matched to web properties, said system comprising:
at least one processor;
a network interface;
a computer readable medium in communication with said at least one processor, said computer readable medium storing computer processing instructions executable by said at least one processor to provide:
a content collection component for receiving a plurality of digital content items by way of said network interface;
a content assessment component for determining content attributes of each of said plurality of digital content items;
an audience assessment component for determining audience attributes of an audience of a web property;
a matching component for matching said plurality of digital content items to said web property by assessing said content attributes and said audience attributes; and
a distributing component for selectively distributing said plurality of digital content items to said web property by way of said network interface, in response to said matching.

18. The system of claim 17, further comprising an electronic datastore for storing at least one of said plurality of digital content items, said audience attributes, and said content attributes.

19. The system of claim 17, wherein said matching component calculates a score reflective of a quality of match between a given one of said digital content items and said web property.

20. The system of claim 17, wherein said audience assessment component determines said audience attributes by analyzing historic content consumed by said audience.
